(19) United States
(12) Patent Application Publication
(10) Pub. No.: US 2010/0324201 A1
(43) Pub. Date: Dec. 23, 2010

(54) PROCESS OF FORMING RADICALIZED POLYMER INTERMEDIATES AND RADICALIZED POLYMER INTERMEDIATE COMPOSITIONS

(75) Inventor: Gerard T. Caneba, Houghton, MI (US)

Correspondence Address: MICHAEL BEST & FRIEDRICH LLP, 100 E WISCONSIN AVENUE, Suite 3300, MILWAUKEE, WI, 53202, US

(73) Assignee: MICHIGAN TECHNOLOGICAL UNIVERSITY, Houghton, MI (US)

(21) Appl. No.: 12/666,825

(22) PCT Filed: Jun. 30, 2008
(86) PCT No.: PCT/US08/68773

§ 371 Date: Dec. 28, 2009

(51) Int. Cl. C08L 27/08; C08F 214/08

(52) U.S. Cl. 524/568; 526/343; 525/55

(57) ABSTRACT

Disclosed are free-radical retrograde precipitation processes to product a radicalized polymer or copolymer. A process includes form an admixture of a monomer, a solvent, and a free-radical-forming agent to initiate the polymerization at a temperature above the lower critical solution temperature of the mixture. Polymer radicals are precipitated to form micron-sized or nano-sized particulates. The admixture is cooled to stop the polymerization. The radicalized polymer radical may be mixed with a monomer to form a second radicalized copolymer.

### CROSS-REFERENCE TO RELATED APPLICATIONS

This application claims benefit of U.S. Provisional Patent Application No. 60/947,232, filed Jun. 29, 2007, which is incorporated herein by reference in its entirety.

### STATEMENT REGARDING FEDERALLY SPONSORED RESEARCH

This invention was supported in part by the United States Defense Advanced Research Projects Agency (DARPA), contract #HR0011-06-C-004. The United States Government has certain rights in this invention.

### BACKGROUND

The present invention relates generally to a polymerization process, more particularly, to a free-radical retrograde precipitation process to produce radicalized copolymer.

Polymers are used in many commercial applications. With an increased use, there has been a need for efficiently producing polymers. U.S. Pat. No. 5,173,551 (incorporated herein by reference) discloses the use of free-radical retrograde-precipitation polymerization (FRRPP) process for producing polymers. The process is useful for producing both block and random copolymers. This process allows for the control of the radical concentration of the polymer particles. There is a need in the art for producing stronger and more stable materials that have greater elasticity properties.

### SUMMARY OF INVENTION

In one embodiment, the invention provides a process for producing a radicalized polymer. The steps include forming an admixture of reactants including a monomer, a solvent, and a free-radical forming agent. A free radical polymerization reaction is initiated to form a plurality of polymer radicals by maintaining the temperature above the lower critical solution temperature of the admixture, precipitating the radicals at reactor operating conditions to produce a solid yield of radical particulates with an average particulate size of about 200 μm or less, about 150 μm or less, or about 100 μm or less under stirred and flow conditions, rapidly cooling the reactor particulate dispersion, and storing the radical particulates in oxygen-free dry or wet conditions at relatively low nonreactive temperatures.

In another embodiment the invention provides a process of producing a radicalized copolymer. The steps include forming an admixture of reactants comprising a first and second monomer, a solvent, and a free-radical forming agent and initiating a free-radical precipitation polymerization reaction to form a plurality of polymer radicals by maintaining the temperature above the lower critical solution temperature of the admixture. The radical copolymer is precipitated at reactor operating conditions to produce a solid yield of copolymer radical particulates with an average particle size of about 100 μm or less under stirred or flow conditions. The process includes rapid cooling of the reactor particulate dispersion and storing the copolymer radical particulate dispersion in oxygen-free dry or wet conditions at relatively low nonreactive temperatures.

Other aspects of the invention will become apparent by consideration of the detailed description and accompanying drawings.

### BRIEF DESCRIPTION OF THE DRAWINGS

FIG. 1 is a graph showing the precipitation fractionation data for (A) RB1-222 and (B) RB1-232.

FIG. 2 are DSC/TGA heating curves for (A) a PVDC generated via the FRRP process with a melting transition of 180° C., (B) a Zonyl TA-N polymer with a melting transition of 60-70° C., and (C) a VDC-Zonyl copolymer with a melting transition at 100° C., 150° C., and 200° C.

FIG. 3 is a depiction of the polymer chemistry reaction for RB1-215.

FIG. 4 is a depiction of the bulk morphology of RB1-215 copolymer.

FIG. 5 is a graphical representation of the dispersion window for the BASF-RB1-201 product.

FIG. 6 is a DSC/TGA heating and cooling curve for the RB1-215 copolymer.

FIG. 7 are ¹³C NMR spectra of (A) Zonyl TA-N monomer in hot deuterated DMF, (B) VDC-stat-Zonyl TA-N copolymer in hot deuterated DMF after the first stage of polymerization, and (C) (VDC-stat-Zonyl TA-N)-block-(Zonyl TA-N-stat-GMA) copolymer and unreacted Zonyl TA-N in hot deuterated DMF after a second stage of polymerization.

FIG. 8 is a micrograph of RB1-01 showing particle size less than about 100 μm.

FIG. 9 is a micrograph of RB1-03 showing particle size less than about 100 μm.

### DETAILED DESCRIPTION

Free radical retrograde precipitation polymerization (FRRPP) is a chain polymerization process in which monomers are reacted with free radicals in a solution environment, which forms an immiscible polymer-rich phase when a minimum amount of a polymer of a minimum size is produced (phase separation or precipitation) as described in U.S. Pat. No. 5,173,551, incorporated herein by reference. In a retrograde polymer solution system, phase separation occurs when the temperature is increased above a lower critical solution temperature (LCST), which is the minimum temperature at which phase separation can occur.

An embodiment of the invention is a process of producing a radicalized polymer dispersion via FRRPP process. The process includes forming an admixture of reactants comprising monomers such as vinylidene chloride (VDC), a solvent/precipitant, and a free-radical forming agent. A free-radical precipitation polymerization reaction to form a plurality of polymer radicals is initiated by maintaining the temperature above the lower critical solution temperature (LCST) of the admixture. The radicals are precipitated by cooling the mixture, and the radicals form micron-sized or nano-sized particulates. The polymer radical particulates are suitably less than about 200 μm, less than about 100 μm, less than about 80 μm, less than about 60 μm, or less than about 20 μm. A radicalized polymer is a polymer molecule that contains at least one radical site in a form that can be stabilized in an oxygen-free environment, and then later reactivated by the presence of additional monomer molecules under conditions favoring chain extension.

The solvent used in the process is selected such that the polymer-rich phase of the admixture that ensues during polymerization can be maintained in the reactor system at a temperature above the LCST of the admixture. By “LCST” as used herein, it is meant the temperature above which a polymer will become less soluble in a solvent/polymer admixture as the temperature of the admixture is increased. A pressurized (10 atm) cloudpoint experimental system may be used to determine the LCSTs of polymer-solvent systems (see Example 1).

The solvent is preferably such that the viscosity of a resulting polymer-rich phase is suitable for mixing. Additionally, the solvent is preferably such that its use will help reduce free-radical scavengers present in the admixture of reactants. Solvents useful in the present process include, but are not limited to, organic and inorganic solvents such as acetone, methylethylketone, diethyl-ether, n-pentane, isopropanol, ethanol, dipropylketone, n-butylchloride, and mixtures thereof. Useful mixed solvent systems include, but are not limited to, ethanol/cyclohexane, water/methyl ethyl ketone, water/higher ketones such as water/2-pentanone, water/ethylene glycol methyl butyl ether, water propylene glycol propyl ether, glycerol/guaiacol, glycrol/m-toluidine, glycerol/ethyl benzylamine, water/isoporanol, water/t-butanol, water/pyridines, and water/piperidines. For a purely organic system, methanol can be substituted for water in the preceding list of mixed solvents. The solvent is also preferably employed in its fractionally distilled form. A preferred embodiment may use the solvent azeotropic-t-Butanol/2-butanone. The solvent is suitably an azeotropic mixture of t-butanol/methyl ethyl ketone (MEK) (about 64/36 wt/wt).

A free-radical generator, or free-radical-forming agent, is used for initiation of the polymerization. A monomer may be a free-radical based monomer, which is one that polymerizes through the presence of free-radicals. Free radicals are generated to initiate polymerization by the use of one or more mechanisms such as photochemical initiation, thermal initiation, redox initiation, degradative initiation, ultrasonic initiation, or the like. Preferably the initiators are selected from azo-type initiators, peroxide type initiators, or mixtures thereof. Examples of suitable peroxide initiators include, but are not limited to, diacyl peroxides, peroxy esters, peroxy ketals, di-alkyl peroxides, and hydroperoxides, specifically benzoyl peroxide, deconoyl peroxide, lauroyl peroxide, succinic acid peroxide, cumere hydroperoxide, t-butyl peroxy acetate, 2,2 di(t-butyl peroxy)butane di-allyl peroxide), cumyl peroxide, or mixtures thereof. Examples of suitable azo-type initiators include, but are not limited to azobisisobutyronitrile (AIBN), 2,2′-azobis(N,N′-dimethyleneisobutyramide)dihydrochloride (or VA-044 of Wako Chemical Co.), 2,2′-azobis(2,4-dimethyl valeronitrile) (or V-65 of Wako Chemical Co.), 1,1′-azobis(1-cyclohexane carbonitrile), and acid-functional azo-type initiators such as 4,4′-azobis(4-cyanopentanoic acid). Highly preferred free-radical-forming agents of the present invention are AIBN, V-65, and VA-044.

The initiator is introduced into the system either by itself or as an admixture with a solvent or monomer. Preferably, the initiator is introduced into the reactor system already having been admixed with the first monomer.

A reactor system for practicing the process of the present invention is described in U.S. Pat. No. 5,173,551. A system which is useful in the practice of the present invention includes a stirred tank reactor having a stirrer capable of providing agitation at 300 to 600 rpm; a temperature sensor/probe; a means of heating and cooling the reactor and its contents, and a controller to maintain or adjust the temperature of the reactor contents; a means of providing an inert gas into the reactor; a reservoir for holding an admixture of one or more of solvent, monomer, and initiator; and a pump or other means for moving the contents of the reservoir to the reactor. The reactor may also be fitted with a reflux condenser. One of skill in the art will be able to adapt the method of the present invention for use in other reactor systems including other batch reactor systems, semi-batch reactors, and tubular reactors.

The initiator preferably is introduced at a proportion ranging up to 15,000 milligrams of initiator per milliliter of monomer, suitably up to about 100 milligrams initiator per milliliter of monomer, suitably about 5-20 milligrams initiator per milliliter of monomer, and more suitably about 10 mg/ml. The amount of solvent is preferably of about the same general order of magnitude as the monomer. However, the amount may be more or less, depending upon factors such as the particular operating conditions and kinetics desired, and the characteristics desired in the final polymer. For example, the solvent to polymer ratio may be at least 5 or up to 50. These conditions may be adjusted by one skilled in the art.

In addition to solvent, monomer, and initiator, other minor constituents as known in the art may also be included in the admixture. Care is taken to minimize the presence of scavenger constituents that might inhibit the desired free radical reactions capable within the present preferred system. To help minimize the presence of undesired scavengers in the admixture of reactants one or more of following steps are preferably performed: (1) removing inhibitor that may be present initially in the monomer by extraction with a caustic solution, followed by extraction of excess caustic material with distilled water and vacuum fractional distillation, or by passing the monomer through an ion exchange resin column; (2) bubbling nitrogen gas for a predetermined amount of time through the admixture of reactants; or (3) blanketing the reactor chamber with a substantially non-reactive gas, such as nitrogen, preferably at a pressure greater than that of the solvent vapor pressure.

After the reactants are introduced into the reaction chamber, the reaction chamber is heated with a nitrogen blanket on the vapor space; a polymerization reaction is initiated in a suitable manner; and the reactants are allowed to react (to polymerize and precipitate as a polymer) at a substantially constant temperature and pressure for a predetermined amount of time. Polymerization may occur under stirred flow conditions.

Termination of precipitated polymer radicals can be accomplished by one or more steps such as reducing the temperature of the reaction chamber; adding a suitable solvent for the resulting polymer; adding a suitable chain transfer agent (e.g. a mercaptan-type agent) to the system; introducing a suitable radical scavenger (e.g., oxygen from air); or by vaporizing some of the solvent in the reactor. In order to reduce the polymerization or polymerization rate and preserve the activity of the radicalized polymer, the reactor fluid may suitably be cooled relatively quickly and the radicalized polymer dispersion stored in a substantially oxygen-free condition at a low enough temperature for the radical sites to be mass transport and kinetically dormant. A suitable method to achieve this dormant state is to maintain the reactor operating temperature and pressure while passing the reactor fluid through cooling coils and into a nitrogen-purged vessel. The polymerization or polymerization rate may be reduced by cooling the admixture. The radicalized polymer may be cooled to below the glass transition temperature (Tg) or melting temperature and stored below the glass transition temperature (Tg) or melting temperature of the particulates. The temperature of the fluid may suitably reach about 2 to 60° C. below, and more suitably about 30° C. below, the effective glass transition temperature (Tg) or melting temperature of the polymer particulates. The radicalized polymer may suitably be stored at a temperature in the range of from about 2 to about 60° C. below the effective glass transition temperature (Tg), and more suitably at a temperature at least about 30° C. below the Tg or melting temperature of the polymer particulates. One may use the Flory-Fox equation to calculate Tg. Tg may also be calculated from the weighted average of the Tg of each homopolymer that comprises the copolymer and the melting temperatures of solvents within the polymer material. As demonstrated in the examples of vinylidene chloride radicalized polymer/copolymer at temperatures ranging from 110-120° C. and pressure ranging from 45-200 psig, ⅛-inch metal cooling coils immersed in an ice-water is a suitable means for cooling. The cooling may be rapid enough to preclude termination reactions. Suitably, the rate of cooling is faster than the reaction termination rates, and reaction termination renders the radical sites in the polymer unreactive. The cooling rate may be at least 2° C./hour, at least about 5° C./hour, at least about 10° C./hour, at least about 20° C./hour, at least about 25° C./hour, at least about 30° C./hour, or at least about 35° C./hour.

A further embodiment includes a further process of making a second radicalized block polymer by mixing radicalized vinylidene chloride polymer particulates with a first monomer. The formation of a second radicalized copolymer can be altered by controlling the solution environment, pressure, and temperature of the admixture, followed by rapid cooling of the second radicalized polymer to below the effective glass transition temperature of the particulates (Tg). The process can further include mixing a second monomer to the second radicalized block copolymer, and repeating the process. This process may be repeated a number of times by adding a subsequent polymer, i.e., a third polymer, a fourth polymer, etc, to the previously made radicalized copolymer forming a subsequent radicalized copolymer. A first monomer, a second monomer, a third monomer, and subsequent monomer may be monomers known in the art, the types of monomers including, but not limited to vinylidene chloride (VDC), methyl methacrylate (MMA), hydroxyethyl methacrylate (HEMA), vinyl chloride (VC), butyl acrylate (BA), butylene (Bu), ethylene oxide (EO), ethylene (E), butadiene (B), isoprene (I), vinyl acetate (VAc), vinyl alcohol (VOH), acrylonitrile (AN), acrylamide (AMD), vinyl butyral (VBL), acrylic acid (AA), fluorocarbon monomers, silicone monomers, GMA (glycidyl methacrylate), acrylic acid, diacetone acrylamide, tetrafluoroethylene (TFE), chlorotrifluoroethylene (CTFE), vinylidene fluoride (VDF), vinyl fluoride (VF), and E.I. du Pont's Zonyl™ monomers, such as Zonyl-TA-N and Zonyl TM, and mixtures thereof. The first monomer and second monomer may be the same monomer or different monomer. As used herein, a “controlling a solution environment” may include, but is not limited to, adding a suitable solvent, adding a suitable chain transfer agent, adding a suitable radical scavenger, or vaporizing some of the solvent. Once the radical polymer particulate in the first stage is formed and a second set of monomers are added in the second stage, polymerization may occur by any suitable type of radical polymerization method. Suitably, the temperature in the second reactor stage may not be above the LCST.

An even further embodiment of the invention is a process of making radicalized copolymers by mixing the radicalized polymer particulates with a fluorocarbon monomer. Preferable fluorocarbon functional monomers are known in the art and include, but are not limited to, e.g., Zonyl®TA-N, Zonyl®TM, fluoroalkylacrylates, and fluoroalkyl olefins. A preferred embodiment may use Zonyl®TA-N or Zonyl®TM (see DuPont™ Zonyl® Fluorochemical Intermediates, 2002, incorporated herein by reference) The process includes forming an admixture of a monomer, a fluorocarbon functional monomer, a solvent, and a free-radical forming agent; and initiating a free-radical precipitation polymerization reaction to form a plurality of copolymer radicals. A “copolymer” is a polymer produced from at least two different monomers.

The copolymer may be a pure block polymer, a tapered block copolymer, a statistical copolymer, or a random copolymer. A pure block polymer is one consisting of a large block of one type of monomer unit, and a large block of another monomer unit. A tapered-block copolymer is one having blocks of one monomer unit, followed by blocks of another monomer unit, where the size of the blocks of one monomer unit are large on one end of the polymer and gradually become smaller toward the other end, as blocks of the second monomer gradually become larger. A random copolymer is one having a random sequence of different monomer units. A statistical copolymer is a copolymer in which the sequential distribution of the monomeric units obeys known statistical laws; e.g., the monomer sequence distribution may follow Markovian statistics of zeroth (Bernoullian), first, second, or a higher order.

The type of copolymer desired, i.e., block, tapered block, or statistical or random copolymer, can be controlled by reaction conditions. A block or tapered block copolymer can be formed by the addition of all or most of the monomer/free radical generator admixture with the initial charge. A random copolymer can be formed by a delayed and/or continuous feed of the monomer and initiator admixture. The capability shown in the present invention to produce these materials from single-stage free-radical copolymerization chemistry is not normally possible in conventional bulk, solution, dispersion, suspension, emulsion, and precipitation environments. Thus, the present invention may affect monomer sequences in copolymers in ways that are not possible with conventional single-stage copolymerization methods.

The formation of the polymer particulate dispersion with high yields of solid polymer radicals (radicalized polymer) and converted polymer/copolymer products is made possible by high levels of intermolecular and intramolecular cohesion polymer/copolymer and/or the presence of surface active segments. Surface active segments in the polymer/copolymer may concentrate on the surface of the particulates. Examples of surface active segments come from fluorinated monomers, such as tetrafluoroethylene (TFE), chlorotrifluoroethylene (CTFE), vinylidene fluoride (VDF), vinyl fluoride (VF), and E.I. du Pont's Zonyl™ monomers, such as Zonyl-TA-N and Zonyl TM. Also, surface activity can come from silicone-based monomers. As used herein, “surface-active monomer” is a monomer with surfactancy properties. Another source of particulate stabilization is the presence of strong cohesive forces in the polymer/copolymer, which can be manifested by the relatively high levels of crystallinity, although it is the solid density that provides a good quantitative measure of the effect of these cohesive forces. As it can be seen in Table 1 below, the cutoff specific gravity that includes fluorinated and other halogenated polymers is above 1.3. Another consideration is the need for the reactor fluid to not be a solvent nor even a swelling agent to the polymer.

TABLE 1
Specific gravities of free-radical-based polymers.

| Polymer | Specific Gravity |
|---|---|
| Low density polyethylene, LDPE | 0.912-0.925 |
| Polystyrene, PS | 1.04 |
| Poly(vinyl acetate), PVA | 1.191 |
| Poly(methyl methacrylate), PMMA | ~1 |
| Polyvinylchloride, PVC | 1.39-1.43 |
| Poly(vinylidene chloride), PVDC | 1.67-1.97 |
| Poly(vinylidene fluoride), PVDF | 1.75-1.80 |
| Polyvinylfluoride, PVF | 1.38-1.72 |
| Polytetrafluoroethylene, PTFE | 2.18 |
| Polychlorotrifluoroethylene, PCTFE | 2.075-2.185 |

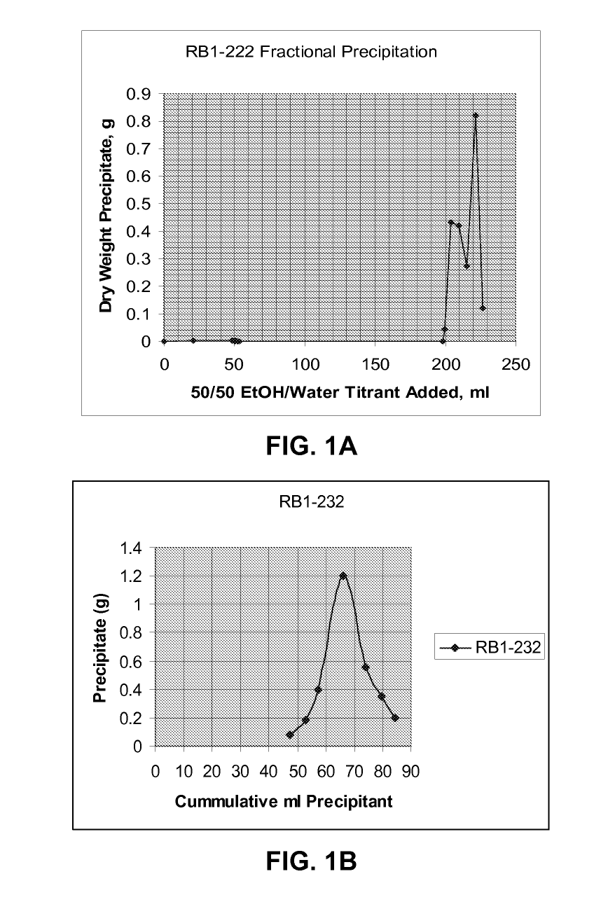

It is envisioned that the radicalized copolymers formed according to the invention may be used in the production of block copolymers. This process comprises the mixture of the radicalized copolymer with a second set of monomers and the continuation of polymerization. Controlling the solvent environment, pressure, and/or temperature of said mixture of the reactants to effect chain extension is employed usually by slowly raising the fluid temperature in the second stage reactor system to a temperature great enough for propagation reactions. The temperature may be raised to at least 25° C., and more suitably, to at least 40° C. A “swollen” particulate has a second set of monomer(s) in the vicinity of the radical sites without reacting, which is achieved by exposure of reactive particulates to the second set of monomers at a low enough temperature for mass transfer to occur without causing the continuation of propagation reaction to take place to form a block copolymer. The radicalized polymer from the first stage reactor should at least be swollen in the second stage reactor in order for the propagation to continue when the reactor fluid temperature is raised while keeping it under positive oxygen-free pressure. Otherwise, core-shell effects may occur, i.e., the interior of the radicalized polymer will not react to form block copolymer. The second stage may begin with a swelling step, the temperature may then be raised, to minimize core-shell effects. Core-shell polymer particulates are those with composition differences between the inner and surface portion of the particulates. For example, the surface may be a block copolymer while the interior may be a statistical copolymer or homopolymer. If the solvent environment is such that the radicalized polymer particulates are just swollen, then it is possible to maintain live radicals within the swollen particulates even during chain extension. If the solvent environment is such that the particulates are not swollen, then ensuing reaction may occur mostly on the particle surfaces. If the solvent environment is such that the radicalized polymer particulates are dissolved during chain extension, then there would be substantial chain termination. The disadvantage of chain extension in swollen radicalized particulates is the formation of a product gradient within the swollen particulates; thus, a nonuniform product is formed, as demonstrated by the bimodal block copolymer product distribution in the fractionation plots, as seen in FIG. 1A. The advantage of chain extension while the polymer is completely dissolved is the uniform block copolymer product distribution, as seen in the RB1-232 product (FIG. 1B). A core-shell particle morphology may be preferred in certain applications, such as in coatings and polymer additive applications. Such an approach is particularly attractive if some of the monomers used contain crosslinking sites.

It is envisioned that the radicalized polymer/copolymer particulates of the invention may be used as additives in the further production of block polymers. The addition of the block copolymers from radicalized vinylidene chloride or radicalized copolymer may add stability, strength, and thermostability to base polymers. One specific embodiment is the use of the block copolymers from radicalized vinylidene chloride copolymers to toughen commercial vinylidene chloride copolymers, such as Saran™.

Copolymers of the present invention may be useful in many applications, including as polymer additives, coatings, surface agents, fibers, foams, films, thickeners, and as interfacial agents for wood, PVC, polyurethane, paper, and textiles.

### EXAMPLES

### Example 1

### Determination of Lower Critical Solution Temperature (LCST)

Using a pressurized cloudpoint cell system, an appropriate solvent was selected for the formation of PVDC copolymer radicals. Phase separation as temperature increases is associated with the so-called lower critical solution temperature (LCST). A search was made for LCST values to be used in the polymerization systems.

Theoretical calculations of conditions needed for the critical first stage of formation of live poly(vinylidene chloride) copolymer radicals were completed. Correlation equations for the LCST values were obtained from Hongwei Liu and Chongli Zhong (Ind. Eng. Chem. Res. 2005, 444, pp. 634-638), which is based on molecular connectivity indices. Table 2 shows the predicted LCST values for the poly(vinylidene chloride)-small molecule systems. The predicted LCST values were generally high, i.e., above 200° C. To obtain an idea of the accuracy of these values, a prediction was made with polystyrene-small molecule systems, which had LCST values reported in the literature (Table 3). The theoretical approach overpredicted LCST values with ether, acetone, MEK, t-butyl acetate, and isopropyl acetate, which belong to the branched class of small molecular systems. Therefore, the LCST values for PVDC using acetone, MEK, t-butyl acetate, and isopropyl acetate, as well as those with highly branched alcohols, ethers, and chlorinated hydrocarbons (if available), were investigated experimentally.

TABLE 2
Theoretical prediction of LCST values for poly(vinylidene
chloride)-small molecule systems.

| | | | | | LCST/ |
|---|---|---|---|---|---|
| | LCST | LCST | Boiling | Boiling | Boiling |
| | K | ° C. | Point K | Point ° C. | Point K |
| PVDC and | | | | | |
| Non-Solvents | | | | | |
| Methanol | 554 | 281 | 338 | 65 | 1.639 |
| Ethanol | 574 | 301 | 351 | 78 | 1.635 |
| 1-butanol | 589 | 316 | 390 | 117 | 1.51 |
| 1-octanol | 662 | 389 | 469 | 196 | 1.412 |
| Acetone | 539 | 266 | 329 | 56 | 1.638 |
| Methylethylketone | 545 | 111 | 353 | 80 | 1.544 |
| Diethyl ketone | 586 | 313 | 375 | 102 | 1.563 |
| dipropyl ketone | 646 | 373 | 417 | 144 | 1.549 |
| n-butane | 529 | 256 | 272.5 | −0.5 | 1.941 |
| n-pentane | 555 | 282 | 309 | 36 | 1.796 |
| n-hexane | 585 | 312 | 342 | 69 | 1.711 |
| Cyclopentane | 606 | 333 | 323 | 50 | 1.876 |
| Cyclohexane | 660 | 387 | 354 | 81 | 1.864 |
| Toluene | 698 | 425 | 384 | 111 | 1.818 |
| Ethylbenzene | 707 | 434 | 409 | 136 | 1.729 |
| Methylacetate | 545 | 111 | 331 | 58 | 1.647 |
| Ethylacetate | 573 | 300 | 351 | 78 | 1.632 |
| n-propylacetate | 606 | 333 | 375 | 102 | 1.616 |
| t-butylacetate | 611 | 338 | 371 | 98 | 1.647 |
| Isobutylacetate | 629 | 356 | 384 | 111 | 1.638 |
| n-butylacetate | 629 | 356 | 398 | 125 | 1.58 |
| Water | 504 | 231 | 373 | 100 | 1.351 |
| THF | 606 | 333 | 339 | 66 | 1.788 |
| Trifluoromethane | 561 | 288 | 189 | −84 | 2.968 |
| Trichlorotri- | 647 | 374 | 319 | 46 | 2.028 |
| fluoroethane | | | | | |
| 1,1-difluoroethane | 561 | 288 | 248 | −25 | 2.262 |
| Chlorotrifluoro- | 623 | 350 | 245 | −28 | 2.543 |
| ethylene | | | | | |
| Ether | 550 | 277 | 307 | 34 | 1.81 |
| PVDC and | | | | | |
| Solvents | | | | | |
| Tetramethylene- | 589 | 316 | | | |
| sulfoxide | | | | | |
| N-acetyl piperidine | 599 | 326 | | | |
| N-methyl | 589 | 316 | 354 | 81 | 1.664 |
| pyrrolidinone | | | | | |
| Trimethylene sulfide | 529 | 256 | 368 | 95 | 1.438 |
| N-n-butyl | 592 | 319 | | | |
| pyrrolidinone | | | | | |
| diisopropyl sulfoxide | 598 | 325 | | | |
| Tetrahydrothiophene | 557 | 284 | 392 | 119 | 1.421 |
| di-n-butyl sulfoxide | 601 | 328 | | | |
| Cycloheptanone | 582 | 309 | 452 | 179 | 1.288 |
| Cycloctanone | 588 | 315 | 469 | 196 | 1.254 |

TABLE 3
Comparison of theoretical and experimental LCST values for
polystyrene-small molecule systems.

| Polystryene | Theoretical | Theoretical | Experimental | Experimental |
|---|---|---|---|---|
| and solvents | LCST K | LCST ° C. | LCST K | LCST ° C. |
| Toluene | 510 | 237 | 552 | 279 |
| Benzene | 473 | 200 | 525 | 252 |
| i-amylacetate | 458 | 185 | 497 | 224 |
| Cyclohexane | 473 | 200 | 488 | 215 |
| Methyl | 477 | 204 | 488 | 215 |
| cyclohexane | | | | |
| n-propyl | 419 | 146 | 453 | 180 |
| acetate | | | | |
| i-butyl acetate | 442 | 169 | 449 | 176 |
| Cyclopentane | 419 | 146 | 428 | 155 |
| Methyl ethyl | 357 | 84 | 425 | 152 |
| ketone | | | | |
| ethyl acetate | 386 | 113 | 416 | 143 |
| Methyl acetate | 357 | 84 | 389 | 116 |
| i-propyl acetate | 425 | 152 | 385 | 112 |
| t-butyl acetate | 424 | 151 | 360 | 87 |
| ethyl formate | 347 | 74 | 353 | 80 |
| Acetone | 352 | 79 | 340 | 67 |
| Ether | 356 | 83 | 315 | 42 |

The experimental LCST values for the polymer-solvent mixtures was determined using a 10 atm cloudpoint system for PVDC-acrylonitrile-methyl methacrylate (AN-MMA) 1 wt % in t-butanol, PVDC-AN-MMA 1 wt % in methylethyl ketone (MEK), PVDC-AN-MMA 1 wt % in 50/50 wt % t-butanol/MEK mixture, PVDC-AN-MMA 1 wt % in 70% MEK/30% t-butanol mixture, polychlorotrifluoroethylene (PCTFE) 1 wt % in 70% MEK/30% t-butanol mixture, PVDC-VC in 70% MEK/30% t-butanol mixture, and polyvinyl methyl ketone (PVMK) in 70% MEK/30% t-butanol.

PVDC-AN-MMA materials in t-butanol showed no LCST transition, although PVDC-AN-MMA in MEK showed an LCST of 145° C. Further tests were done using mixtures of t-butanol and MEK to lower the cloud point from 145° C. A test of 50/50% t-butanol and MEK showed no cloud point transition. A set of experimental results using 70% MEK/30% t-butanol mixture is shown in Table 4 below.

TABLE 4
Experimental LCST values of VDC copolymers and other polymers
of interest in 70/30 wt/wt MEK/t-butanol.

| Polymer Material | LCST (° C.) |
|---|---|
| PVDC-AN-MMA | 112-123 |
| PVDC-VC | 105-114 |
| PCTFE | 97-107 |
| PVMK | 132-141 |

An azeotropic mixture of t-butanol/MEK (about 70/30 wt/wt) would be a suitable solvent at a reactor operating temperature of 120° C.

### Example 2

### Formation of Particulate Radicalized Poly(Vinylidene Chloride)

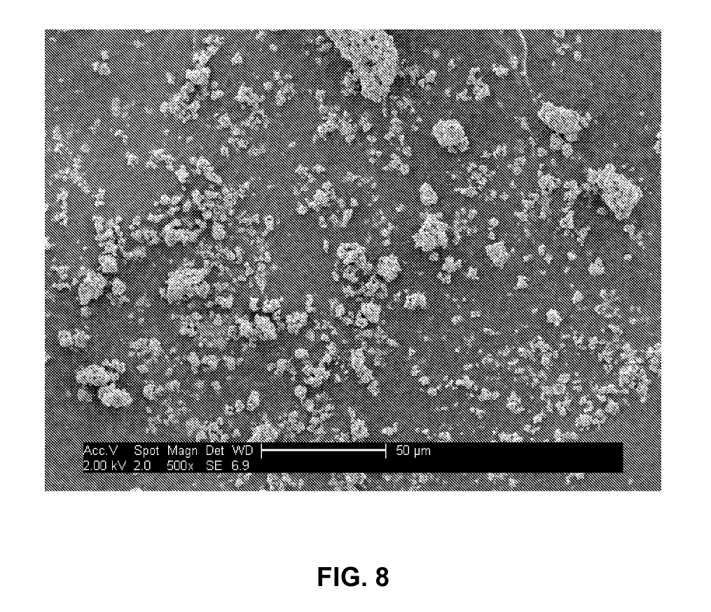

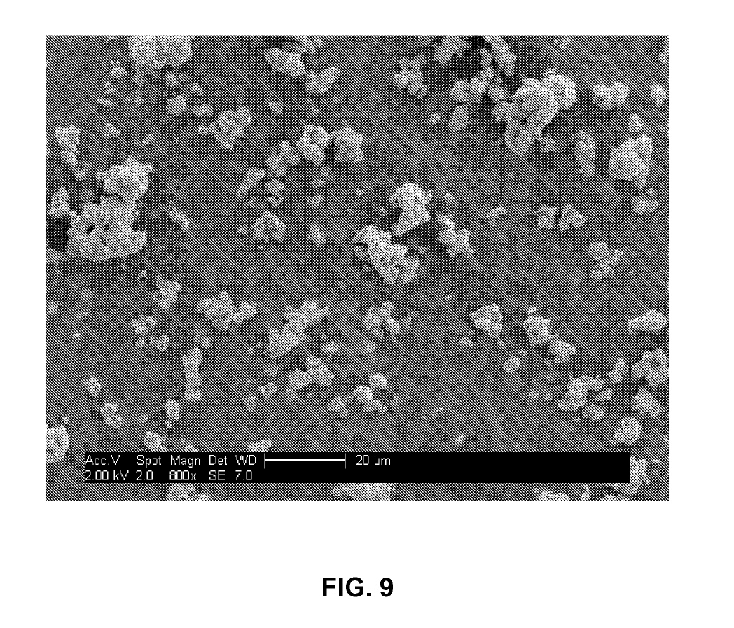

In all reactor experiments, fluids were inerted by bubbling with nitrogen gas for at least 15 minutes. The reaction in a 300 ml Parr metal reactor system with electric heater was used for radicalization of VDC polymer. The reactor was inerted with nitrogen gas using 5 pressure blow cycles from 100 psig to 1 atm, and was finally closed to maintain a small positive pressure (at 10-20 psig). 50 ml of azeotropic t-butanol/2-Butanone (MEK) (36/64 wt/wt) was used as the solvent, the temperature was raised linearly with time to 120° C. over the course of 45 minutes and maintained at this temperature, and the reactor pressure went up to 70 psig. Then, the stock monomer mixture of 20 ml VDC (with 200 ppm MEHQ inhibitor) in 90 ml solvent was pumped into the reactor at 6 ml/min followed by 10 ml solvent flush. 10 ml of 1 wt % AIBN in solvent was pumped into the reactor for 4 minutes and 12 seconds, followed by a 10 ml solvent flush. Samples of reactor contents were drawn through ⅛-inch cooling coils into nitrogen-inerted bottle. The first sample (RB1-1) was taken right after the addition of stock monomer solution. The second sample (RB1-2) was taken 15 minutes after the start of addition of the AIBN solution. The third sample (RB1-3) was taken 1 hr and 40 minutes after the start of the addition of AIBN solution. The Parr reactor was cooled to room temperature in 15-30 minutes and cleaned with DMF followed by THF. Nitrogen was flushed through the reactor chamber in order to blow off and dry out any remaining THF in preparation for the next reaction run. The samples revealed that radical copolymer conversion and solid yields were about 100% for all the samples. FIGS. 8 and 9 are micrographs of RB1-01 and RB1-03, respectively, showing the particle size less than 100 μm.

### Example 3

### Formation of Radicalized Vinylidene Chloride-Zonyl Copolymer

The reaction in a 300 ml Parr metal reactor system with electric heater was used for radicalization of VDC-fluorocarbon (Zonyl) copolymers. The reactor was inerted with nitrogen gas using 5 pressure blow cycles from 100 psig to 1 atm, and was finally closed to maintain a small positive pressure (at least 2 psig). 50 ml of azeotropic t-butanol/2-Butanone (36/64 wt/wt) was used as the solvent, and the temperature was raised linearly with time to 120° C. over the course of 45 minutes and maintained at this temperature. The admixture of 2.4 g of Zonyl TA-N, and 20 ml (24.26 g) of VDC monomer with 200 ppm MEHQ inhibitor in 150 ml of solvent was added to the reactor in 33 minutes, followed by a 10 ml solvent flush. The reactor fluid was then heated at 110° C. for at least 2 additional hours. The reactor contents were cooled quickly to room temperature, and a sample was taken at room temperature. Total yield of polymer was determined using a gravimetric method, where the weight % polymer for 100% conversion is known, for example, by totaling the weight of monomers added to the reaction. This 100% conversion is compared to measuring the weight of a sample reactor fluid, drying out all fluids from the sample, and then weighing remaining polymer residue. The weight of dry polymer residue is compared to the calculated polymer from 100% conversion using the total sample weight. The total yield of polymer was about 62%. The Parr reactor was cleaned with DMF followed by THF. Nitrogen was flushed through the reactor chamber in order to blow off and dry out any remaining THF in preparation for the next reaction run. Results indicated that the Zonyl reduced the overall solid polymer yield, due to its lower reactivity compared to VDC.

### Example 4

### Formation of Diblock Polymer Made of Vinylidene Chloride Copolymer Block With a Methyl Methacrylate-Stat-butyl Acrylate-Stat-Glycidyl Methacrylate Block (Rb1-232)

Stage 1 is formation of the vinylidene chloride copolymer radicals. The Stage 1 reaction was done in a 300 ml Parr metal reactor system with electric heater. The reactor was inerted with nitrogen gas using 5 pressure blow cycles from 100 psig to 1 atm, and it was finally closed to maintain a small positive pressure (at least 2 psig). 50 ml of azeotropic t-butanol/2-Butanone (36/64 wt/wt) was used as the solvent, and the temperature was raised linearly with time to 110° C. in the course of 45 minutes, and then maintained at that temperature. The admixture of 2.8 g of Zonyl TA-N in 29 ml solvent, 24 ml of 1 wt % AIBN in solvent, and 20 ml (24.26 g) of VDC with 200 ppm MEHQ inhibitor in 78 ml of solvent was added to the reactor in 30-45 minutes, followed by a 20 ml solvent flush. The reactor fluid was then heated at 110° C. for at least 6 more hours. Reactor contents were quickly drawn through ⅛-inch cooling coils into nitrogen-inerted bottle. The Parr reactor was cleaned with DMF followed by THF.

Stage 2 is addition of monomers to the VDC copolymer radical to form a diblock copolymer. Stage 2 was done using a 5-liter pressurized (up to 45 psig) glass reactor system with a steam/water jacket. The following was initially charged into the reactor: 50 g of GMA, 150 g of MMA, and 2000 g of NMP. A sample (about 150 ml) was removed from the initial charge before adding the entire Stage 1 product (VDC copolymer radical). The reactor temperature was increased to 70° C. in 4 hrs and was maintained at this temperature for 6 additional hrs. Then, the steam was turned off to cool the reactor to room temperature over the course of 2 additional hrs. About 30 g was removed as sample, and Cycle 1 of Stage 2 operation ended. In Cycle 2, the following was further added into the reactor: 64 g of GMA, 60 g of BA, and 1000 g of NMP. The same temperature cycle was used as in Cycle 1. In Cycle 3, nothing was added, and the same temperature cycle was used. Cycle 4 was a repetition of Cycle 3. The final product (RB1-232), yielded a white and relatively soft solid material.

### Example 5

### High-Throughput Experimentation of Vinylidene Chloride Polymerization

The FRRPP polymerization of vinylidene chloride (VDC) and VDC-Zonyl TA-N was carried out in parallel pressure tubes and in a Stage 1 stirred-tank reactor system. The reaction process was done at 120° C. for about 8 hours, and the total solid yield was about 60%. The high throughput polymerization reaction using a robotic dispensing system containing VDC and Zonyl TA-N was undertaken by varying the amounts of VDC and Zonyl TA-N for 24 samples.

VDC ranged in concentration from 83% to 31%. The percent conversion ranged from 1% to 13% at 120° C. The Zonyl concentration for the three reactions was greater than the VDC concentration and ranged from 83% to 62% Zonyl. No polymers were formed in the reaction, possibly due to oxygen contamination. FRRPP mixture of 36 g of VDC, 3.6 g of Zonyl TA-N, and 1 wt % AIBN initiator in the solvent mixture (methyl ethyl ketone 66%, t-butanol 34%) at 110° C. was commenced for our first stage reaction with a 9% conversion. Sometimes during the first stage reaction additional (3.6 g) Zonyl TA-N was added after the initial monomer, AIBN, and solvent injection. The melting temperature of PVDC was 180° C., and it was thermally stable up to 230° C. PolyZonyl TA-N was synthesized with a 15 wt % solution in t-butanol, methyl ethyl ketone, and 0.5 wt % AIBN relative to monomer content. The melting temperature of PolyZonyl TA-N was 80° C. and 175° C., and it was thermally stable up to 350° C.

### Example 6

### Analytical Results for PVDC, Zonyl, and VDC-Zonyl Copolymer (Stage 1)

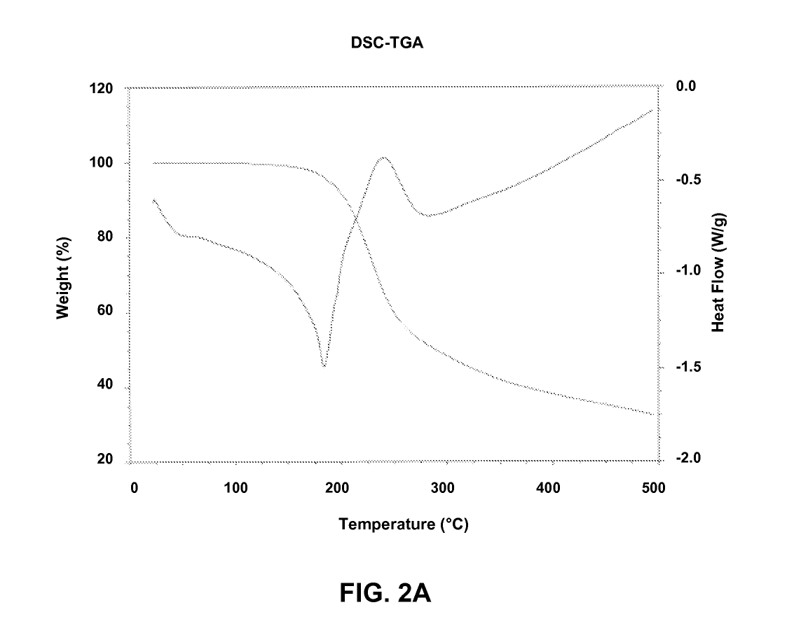

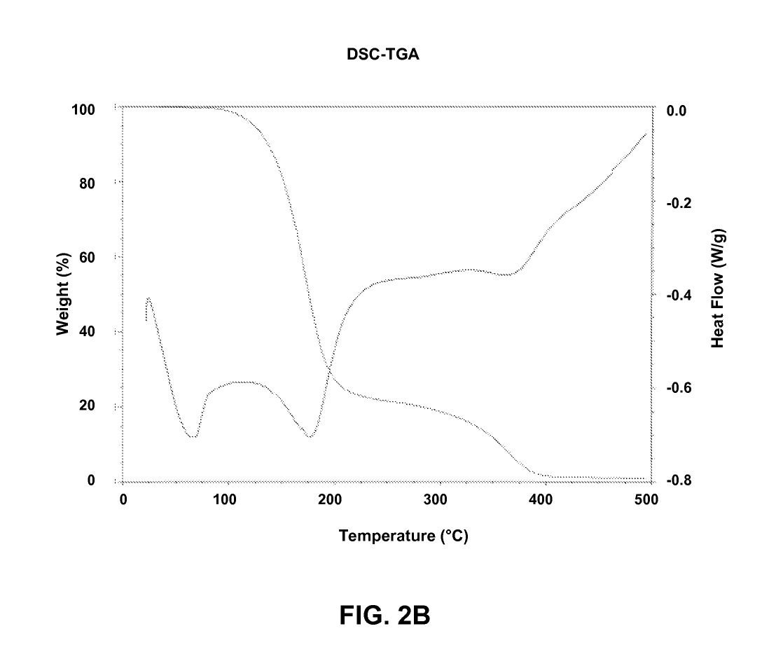

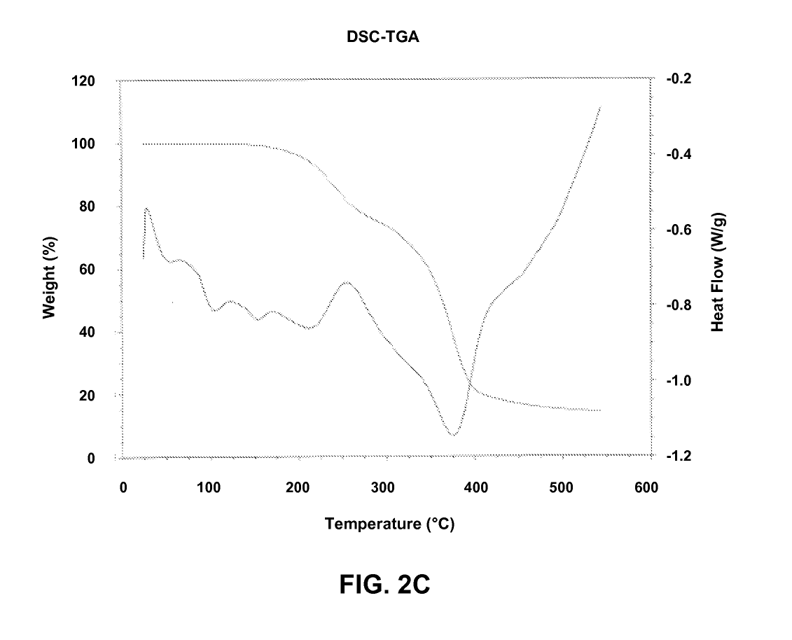

Polymer products were thermally analyzed with DSC/TGA. Results indicated that polymerizations without the adhesion/crosslinking promoter resulted in the synergistic thermal stabilization of both VDC and Zonyl segments. The PVDC homopolymer demonstrated a Tm of 180-190° C. and a Tg of about 60° C. (see FIG. 2A). Above 200° C., however, the weight of PVDC decreased dramatically to 40% its original value at 300° C. The pure Zonyl polymer demonstrated a Tm of 60-70° C. Above 100° C., its weight dramatically decreased to 20% its original value at 200° C. (see FIG. 2B). The VDC-Zonyl copolymer (made according to Example 3) demonstrated additional Tm's at 100° C. and 150° C. (see FIG. 2C), aside from the one at around 200° C. for VDC domains. Also, the weight of the copolymer remained stable up to 200° C. More importantly, increasing the temperature to 300° C. resulted in a decrease of only 20% its original weight. Thus, copolymerization resulted in a material that is more thermally stable (by almost 100° C.) than its homopolymer constituents.

### Example 7

### Synthesis of RB1-215 Copolymer

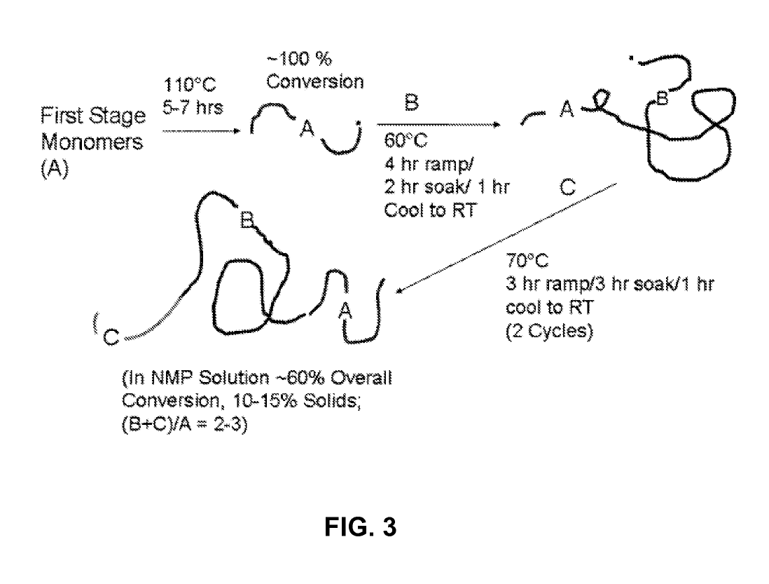

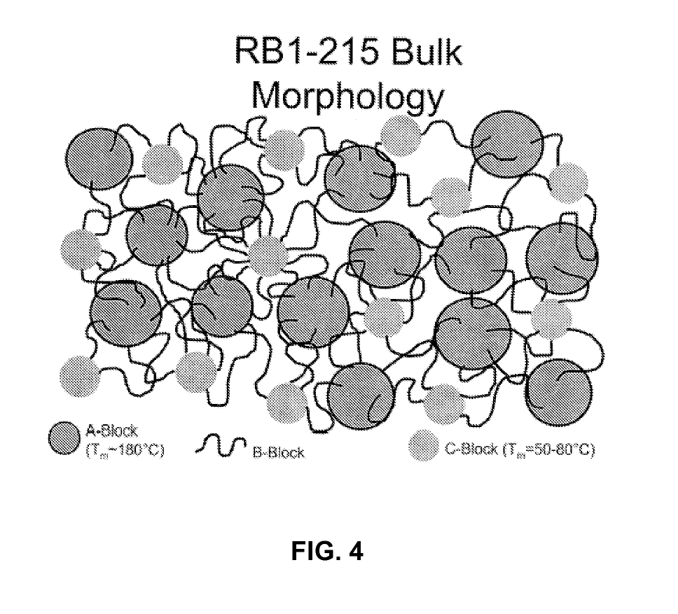

The synthesis process of RB1-215 is depicted in FIG. 3, and FIG. 4 is a cartoon depiction of the bulk morphology. The A-block contained the VDC segments, while its B and C blocks contained both GMA and MMA segments. The B-block further contained BA segments. What made the C block unique is the presence of the Zonyl TA-N or Zonyl TM segments, which have a melting transition of 5° C. to 80° C. For Stage 1, the reactor was inerted with nitrogen gas using 5 pressure blow cycles from 100 psig to 1 atm, and was finally closed to maintain a small positive pressure (at least 2 psig). 50 ml of azeotropic t-butanol/2-Butanone (34/66 wt/wt) was used as the solvent, and the temperature was raised linearly with time to 120° C. over the course of 45 minutes, and maintained at that temperature. The admixture of 3.6 g of Zonyl TM in 50 ml of solvent, 50 ml of VDC monomer, and 30 ml of 1 wt % AIBN in solvent was added to the reactor, followed by a 20 ml solvent flush. The reactor fluid was then heated at 110° C. for at least 2 additional hours. The reactor contents were cooled quickly. The Parr reactor was cleaned with DMF followed by THF. Nitrogen was flushed through the reactor chamber in order to blow off and dry out any remaining THF. Half of the volume of product from Stage 1 was transferred to Stage 2. In Cycle 1 of Stage 2, 20 g of MMA, 25 g of GMA, 250 mL of NMP, and 5 g of BA were added. The temperature was increased to 60° C. over the course of 4 hr, the temperature was held at 60° C. for 4 hr, and the temperature was cooled to room temperature over the course of 1 hr. In Cycle 2 of Stage 2, 10.4 g of Zonyl TM, 10.3 g of MMA, 100 mL of NMP, and 10.1 g of GMA were added. The temperature was increased to 70° C. over the course of 2 hr, the temperature was held at 70° C. for 6 hr, and the temperature was cooled to room temperature over the course of 1 hr. For post-processing (see Example 12), the product was coagulated into a dough, placed in a vacuum oven at 80° C. for 1 hr, and then melt processed at 100-180° C. Melt processing above 120° C. resulted in self-crosslinking and an insoluble elastic material.

### Example 8

### Synthesis of RB1-201 Copolymer and Variants

For Stage 1, the reactor was inerted with nitrogen gas using 5 pressure blow cycles from 100 psig to 1 atm, and was finally closed to maintain a small positive pressure (at least 2 psig). 50 ml of azeotropic t-butanol/2-Butanone (34/66 wt/wt) was used as the solvent, and the temperature was raised linearly with time to 120° C. for 45 minutes, and maintained at that temperature. The admixture of 3.6 g of Zonyl TM in 50 ml of solvent, 50 ml of VDC monomer, and 30 ml of 1 wt % AIBN in solvent was added to the reactor, followed by a 20 ml solvent flush. The reactor fluid was then heated at 110° C. for at least 2 additional hours. The reactor contents were cooled quickly. The Parr reactor was cleaned with DMF followed by THF. Nitrogen was flushed through the reactor chamber in order to blow off and dry out any remaining THF. Half of the volume of product from Stage 1 was transferred to Stage 2. In Cycle 1 of Stage 2, 30 g of Zonyl TM, 21.2 g of GMA, 35.4 g of MMA, and 400 ml, of NMP were added. The temperature was increased to 60° C. over the course of 4 hr, the temperature was held at 60° C. for 1 hr, and the temperature was cooled to room temperature over the course of 1 hr. Half of the Cycle 1 product was transferred to Cycle 2 of Stage 2 where 10 g of GMA, 15 g of MMA, and 163 g of NMP were added. The temperature was increased to 60° C. over the course of 1 hr, the temperature was held at 60° C. for 7 hr, and the temperature was cooled to room temperature over the course of 1 hr. Half of the Cycle 2 product was transferred to Cycle 3 of Stage 2 where 0.4 g of V65-B was added. The temperature was increased to 60° C. over the course of 1 hr, the temperature was held at 60° C. for 5 hr, and the temperature was cooled to room temperature over the course of 1 hr.

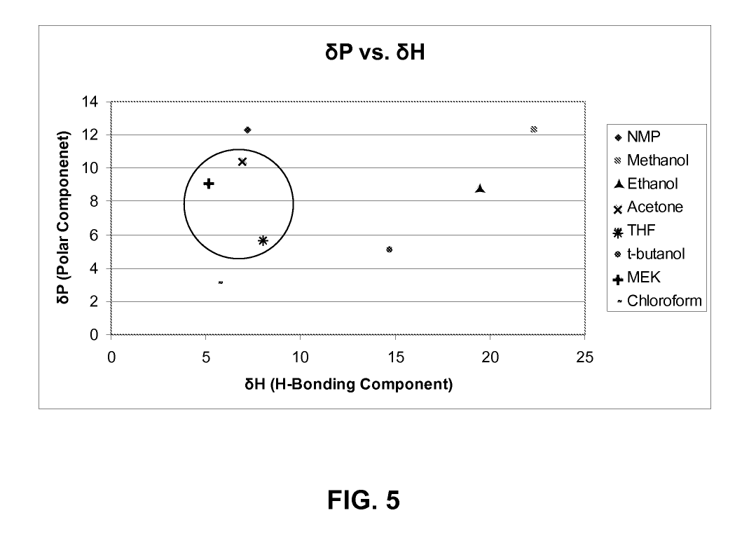

In order to ascertain the chemical properties of the polymer, the polymer was mixed into a variety of solvents at varying concentrations. 0.1 and 1 wt % solutions were made in methanol, ethanol, t-butanol, ethylene glycol, N-methyl-2-pyrrolidinone (NMP), chloroform, methyl ethyl ketone (MEK), acetone, and tetrahydrofuran (THF). Initial testing showed that the polymer was insoluble in methanol, ethanol, t-butanol, and ethylene glycol; slightly soluble in NMP and chloroform; and very soluble in MEK, acetone, and THF. FIG. 5 illustrates the solubility window (the circle surrounding acetone, MEK, and THF) for the polymer on a graph that plots the polar versus hydrogen bonding component of the Hansen Solubility Parameter (Note: ethylene glycol has a hydrogen bonding solubility component greater than 25 MPa^{1/2} and is not plotted on the graph). Along with values of the dispersion component of the Hansen Solubility Parameter, the suggested solubility parameter for the MTU/BASF RB1-201 polymer was about 19.4 MPa^{1/2}.

### Example 9

### Synthesis of RB1-222 Copolymer

Early stages of this work were carried out in high throughput experimentation format. To synthesize the RB1-222 copolymer, Stage 1 reaction was completed as for RB1-201 in Example 8. The Stage 2 reaction was completed as described for the Stage 2 reaction of the RB1-201 in Example 8 with the following exceptions. The contents of the Stage 2 reaction were butyl acrylate (BA), methyl methacrylate, and glycidyl methacrylate (MMA) in N-methylpyrrolidinone (NMP), and glycidyl methacrylate (GMA) with a PVDC-Zonyl TA-N polymer free radical intermediate in azeotropic t-butanol/methyl ethyl ketone. Typically, there were three cycles to the Stage 2 reaction. Cycle 1 contained 340 ml of NMP, 34 g of MMA, 42.5 g of GMA, 8.5 g of BA. Cycle 2 contained 16 g of MMA and 16 g of Zonyl TA-N. Cycle 3 was a heating cycle only without addition of any new monomers. FIG. 3 depicts the overall procedure used to produce reactive block copolymers from this subtrack.

### Example 10

### Formation of Radicalized VDC-Zonyl-GMA Terpolymer

Stage 1 reaction in a 300 ml Parr metal reactor system with electric heater was used for radicalization of VDC-Zonyl-GMA copolymer. The reactor was inerted with nitrogen gas using 5 pressure blow cycles from 100 psig to 1 atm, and it was finally closed to maintain a small positive pressure (at least 2 psig). 50 ml of azeotropic t-butanol/2-Butanone (36/64 wt/wt) was used as the solvent, and the temperature was raised linearly with time to 110° C. over the course of 45 minutes and maintained at that temperature. The reactive admixture of 2.4 g of Zonyl TA-N, 30 g of 1 wt % AIBN in solvent, 20 ml (24.26 g) of VDC with 200 ppm MEHQ inhibitor in 150 ml of solvent, and 2.4 g of GMA was added to the reactor in 36 to 40 minutes, followed by a 10 ml solvent flush. The reactor fluid was then cooked at 110° C. for at least 5 more hours. Reactor sample contents were quickly drawn through ⅛-inch cooling coils into a nitrogen-inerted bottle. The Parr reactor was cleaned with DMF followed by THF. The solid product yield for the sample taken at 5 hrs 46 minutes from the start of injection of reactive mixture was about 100%.

### Example 11

### Analytical Results for RB1-215 Copolymer

DSC/TGA analysis

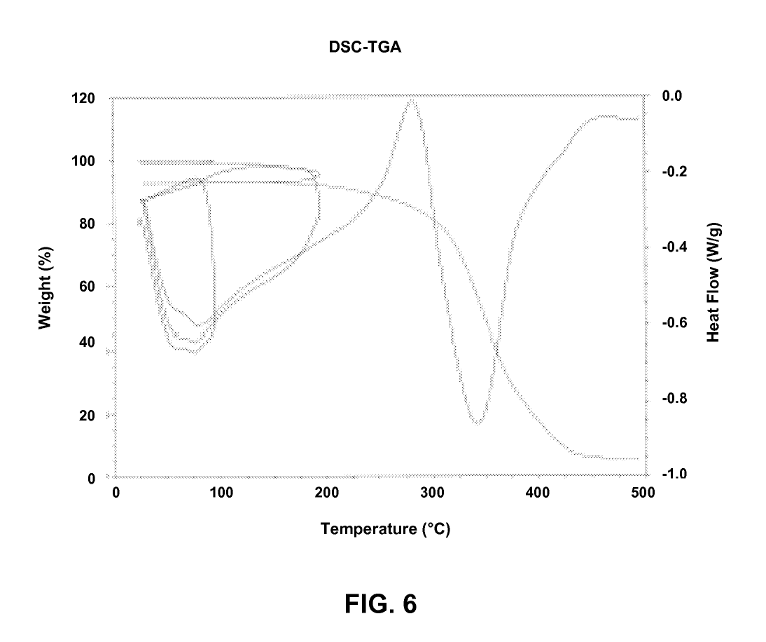

Polymer products were thermally analyzed. Stage 2 copolymer products were even more thermally stable than the Stage 1 VDC-Zonyl intermediate product. For the RB1-215 copolymer, three heating and cooling cycles were used. The first cycle was heating to 100° C. and then cooling to room temperature. The second cycle was heating to 200° C. and then cooling to room temperature. The third cycle was heating up to 500° C. As shown in FIG. 6 for RB1-215 product, the weight of the material decreased to 80% of its original value at 300° C., even after two heating cycles.

NMR Spectroscopy of Monomeric Components, Intermediate, and Final Copolymer Products

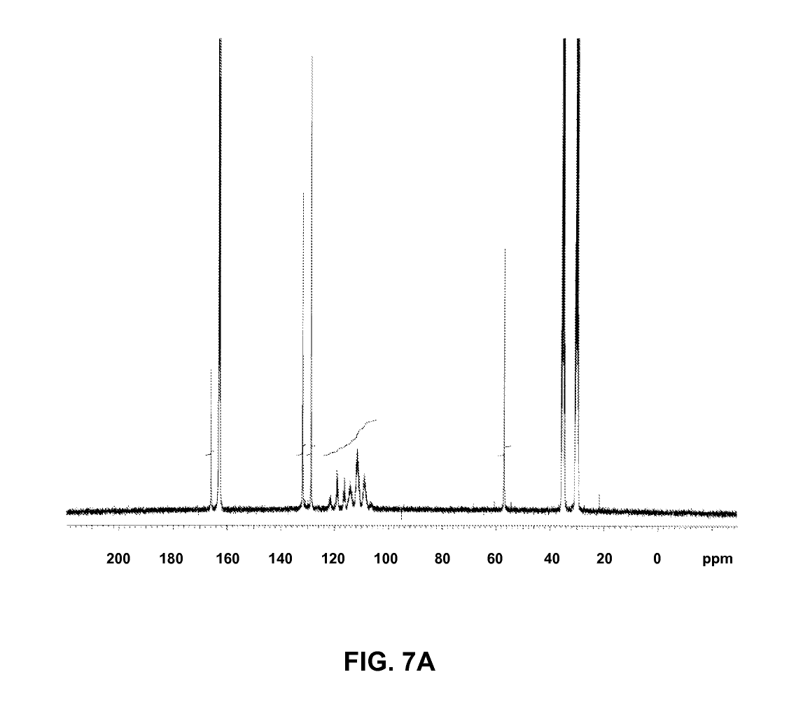

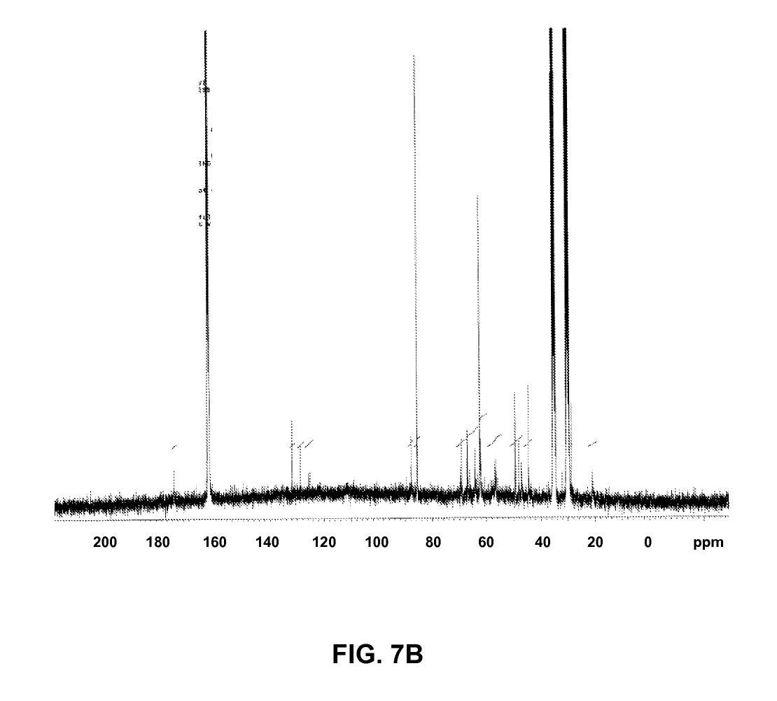

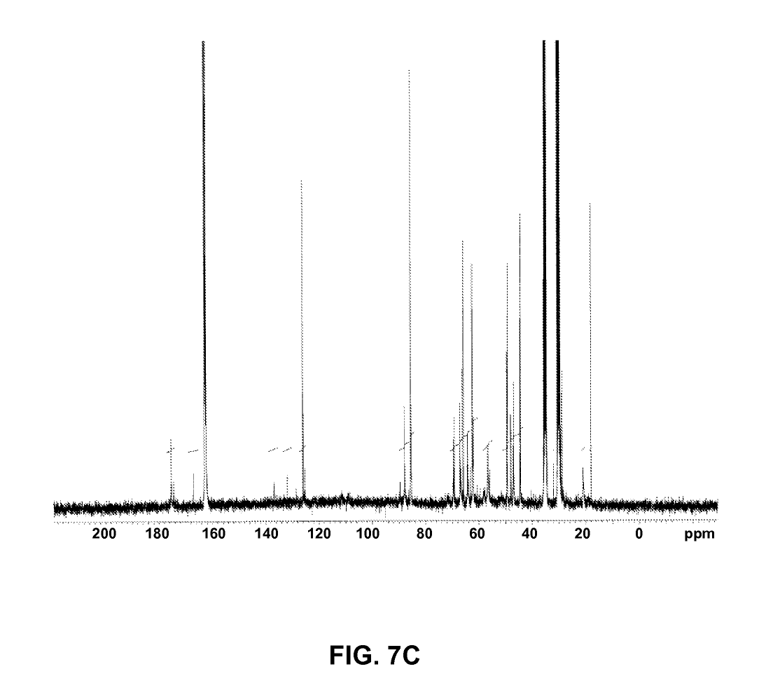

Monomeric components, intermediate products, and final copolymer products were analyzed with ¹³C NMR Spectroscopy. NMR results (FIGS. 7A, 7B, 7C) indicated that monomers were incorporated into the intermediate copolymer radicals from the Stage 1 reactor.

Fractional Precipitation of Products

The polymer RB1-222 (same as RB1-215, except Zonyl TA-N was used instead of Zonyl TM) was fractionated with 50% ethanol/water solution. The polymer solution was diluted to either 10:1 or 5:1 v/v with NMP solvent. FIGS. 1A and 1B depict the fractogram showing little intermediate VDC-Zonyl Stage 1 precipitated with the 0-15 ml precipitant added. A quantitative analysis indicated that the unreacted Stage 1 contamination amounted to less than 1 wt % of the product copolymer. Relatively minimal unreacted Stage 1 contamination was present.

Infrared Analysis

Infrared analysis of one polymer showed two C═O peaks at 1726 and 1684 cm⁻¹ from the acrylate group and one epoxide peak at 907 cm⁻¹. Some epoxide groups were converted into OH groups (10% percent), based on the 3440 cm⁻¹OH band. Poly-GMA was made using 60° C. temperature, 8 g of monomer, and 1 wt % AIBN over 5 minute intervals up to 30 minutes. Only the last sample at 30 minutes was polymerized with 64% conversion. Some GC-MS analysis of the Stage 2 product RB1-219-221 (same run as that for formation of RB1-215) solutions provided the amount of acrylic monomers remaining relative to the N-methylpyrrolidinone solvent amount. The GMA was more incorporated into the polymer than the MMA, followed by BA (Table 5).

TABLE 5
GC-MS analysis of Stage 2 product
of RB1-219-221 (also RB1-215).

| | GMA- | GMA- | MMA- | MMA- | BA- | BA- |
|---|---|---|---|---|---|---|
| RB1- | init | final | init | final | init | final |
| 219 | 17.2% | 1.80% | 14.7% | 2.44% | — | — |
| 220 | 17.2% | 4.07% | 14.7% | 4.08% | 2.50% | 1.31% |
| 221 | 17.2% | 1.26% | 14.7% | 1.82% | — | — |

Init = initial concentration
Final = final concentration

### Example 12

### Post-Processing of Polymer RB1-221

After the Stage 1 and Stage 2 polymerization runs, the final RB1-221 polymer product was separated from the reactor solvents (t-butanol, MEK, and NMP), unreacted monomers (VDC, Zonyl-TA-N, Zonyl-TM, MMA, GMA, and BA), and unreacted initiator (AIBN and V-65B). First, the polymer was coagulated with excess water (3:1 v/v or more) out of the reactor fluid into a gel or dough. Second, solvent and unreacted reactants were extracted from the dough. Third, the dough was dried into a purified and safe-to-handle product. The dough may be melt-blended with other components, if needed.

Coagulation was the process in which the dissolved polymer in the Stage 2 polymerization reactor fluid was precipitated out of solution. By adding water to the reactor fluid product, the chemical environment was altered such that the polymer-solvent interactions became less favorable compared to the polymer-polymer, which resulted in the polymer precipitating out of solution. The reactor fluid, 250 ml, was placed in a glass pan and at least 750 ml water was added. The solvent laden polymer precipitate (around 50:50 polymer:solvent) was then removed from the reactor fluid.

The residual solvent and reactants were removed from the dough. Initial attempts to purify the polymer included one vacuum oven drying step (4 hours at 80° C.) used to drive off the residual solvent, followed by up to three supercritical CO₂ extraction steps (8 hour soak at room temperature and 2000 psig) used to remove unreacted monomers, oligomers, and residual solvent.

This process was later replaced by a more efficient process that involved extracting the solvent and unreacted monomers and oligomers with methanol. Once extracted, the methanol was evaporated from the purified polymer powder. A 500 g quantity of solvent laden “dough” was vigorously mixed with 4-L quantities of methanol. The resulting suspension was then allowed to sit for 1-2 hours until the polymer settled to the bottom, at which time the methanol with extracted solvent and reactants was decanted off. This process was performed a total of 10 times, ensuring a purified polymer. The methanol saturated polymer was then allowed to air dry in the fume hood, and the purified polymer was collected.

While the compositions and methods of this invention have been described in terms of exemplary embodiments, it will be apparent to those skilled in the art that variations may be applied to the compositions and methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention. In addition, all patents and publications listed or described herein are incorporated in their entirety by reference.

As used in this specification and the appended claims, the singular forms “a,” “an,” and “the” include plural referents unless the content clearly dictates otherwise. Thus, for example, reference to a composition containing “a polynucleotide” includes a mixture of two or more polynucleotides. It should also be noted that the term “or” is generally employed in its sense including “and/or” unless the content clearly dictates otherwise. All publications, patents and patent applications referenced in this specification are indicative of the level of ordinary skill in the art to which this invention pertains. All publications, patents and patent applications are herein expressly incorporated by reference to the same extent as if each individual publication or patent application was specifically and individually indicated by reference. In case of conflict between the present disclosure and the incorporated patents, publications and references, the present disclosure should control.

It also is specifically understood that any numerical value recited herein includes all values from the lower value to the upper value, i.e., all possible combinations of numerical values between the lowest value and the highest value enumerated are to be considered to be expressly stated in this application. Thus, the invention provides, among other things, a radicalized polymer intermediates that may be used in the production of various polymer formations. Various features and advantages of the invention are set forth in the following claims.

What is claimed is:

1. A process of producing a radical polymer particulate comprising the steps of:
a) forming an admixture of reactants comprising:
a first monomer;
a solvent; and
a free-radical forming agent;
b) initiating a free-radical precipitation polymerization reaction to form a plurality of vinylidene chloride radical polymers and increasing the temperature of the admixture above the lower critical solution temperature of the admixture;
c) maintaining the temperature of the admixture above the lower critical solution temperature of the admixture;
d) precipitating the radical polymers to produce a dispersion comprising a plurality of radical polymer particulates; and
e) substantially reducing the polymerization of the radical polymer.

2. The process of claim 1, further comprising the step of:
f) storing the radical polymer particulates under conditions that favor substantially no polymerization and maintain activity of the radical for future polymerizations.

3. The process of claim 2, wherein the radical polymer particulates of step (f) are stored under substantially oxygen-free and low-temperature conditions.

4. The process of claim 1 or 2, wherein the first monomer of step (a) is vinylidene chloride.

5. The process of claim 1 or 2, wherein the radical polymer particulates have an average particle size of about 100 μm or less in any dimension.

6. The process of claim 1, wherein the polymerization in step (e) is substantially reduced by cooling the dispersion to a temperature below the effective glass transition temperature of the particulate.

7. The process of claim 6, wherein the dispersion is rapidly cooled at a rate of at least 5° C./hour.

8. The process of claim 2, further comprising:
g) mixing the radical polymer particulates with a second monomer and/or a solvent, the second monomer being the same or different type than the first monomer;
h) continuing polymerization by increasing the temperature of the admixture to a temperature above 25° C. to form a plurality of radical block copolymers;
i) maintaining the temperature of the admixture such that polymerization occurs; and
j) substantially reducing the polymerization and forming a first radical block copolymer.

9. The process of claim 2 further comprising:
g) mixing the radical polymer particulates with a second monomer and a free-radical-forming agent in a solvent, the second monomer being the same or different type than the first monomer; and
j) substantially reducing the polymerization and forming a first radical block copolymer.

10. The process of claim 8 or claim 9 further comprising:
k) mixing the radical polymer particulates with a third monomer and/or a solvent, the third monomer being the same or different type than the first and second monomers;
l) continuing polymerization by increasing the temperature of the admixture to a temperature above 25° C. to form a plurality of radical block copolymers;
m) maintaining the temperature of the admixture such that polymerization occurs; and
n) substantially reducing the polymerization and forming a first radical block copolymer.

11. The process of claim 8 or 9 further comprising:
k) mixing the first radical block copolymer with a third monomer, the third monomer being the same or different type than the first and second monomers; and
l) substantially reducing the polymerization and forming a second radical block copolymer.

12. The process of claim 10 or 11, wherein steps (k) through (n) are repeated with the same or different monomers to form subsequent radical block copolymers.

13. The process of claim 8 or 9, wherein the second monomer of step (g) is a free-radical-based monomer.

14. The process of claim 8 or 9, wherein the second monomer of step (a) is a surface-active monomer.

15. The process of claim 14 wherein the second monomer of step (a) is selected from the group consisting of fluorocarbons or silicone.

16. The process of claim 14, wherein the second monomer of step (a) is selected from the group consisting of TFE, CTFE, VDF, and VF.

17. A process of producing a radical random copolymer comprising the steps of:
a) forming an admixture of reactants comprising:
a first monomer;
a second monomer;
a solvent; and
a free-radical forming agent;
b) initiating a free-radical precipitation polymerization reaction to form a plurality of radical random copolymers;
c) maintaining the temperature above the lower critical solution temperature of the admixture;
d) precipitating the radical random copolymer to produce a dispersion comprising a plurality of radical random copolymer particulates; and
e) substantially reducing polymerization.

18. The process of claim 17, further comprising the step of:
f) storing the radical random copolymer particulates under conditions that favor substantially no polymerization and maintain activity of the radical for future polymerizations.

19. The process of claim 18, wherein the radical copolymer particulates of step (f) are stored under substantially oxygen-free and low-temperature conditions.

20. The process of claim 17 or 18, wherein the radical copolymer particulates have an average particle size of about 200 μm or less in any dimension.

21. The process of claim 17, wherein the polymerization rate in step (e) is substantially reduced by cooling the dispersion to a temperature below the effective glass transition temperature of the particulate.

22. The process of claim 17, further comprising:
g) mixing the radical polymer particulates with a third monomer and/or a solvent, the third monomer being the same or different type than the first and second monomers;
h) continuing polymerization by increasing the temperature of the admixture to a temperature above 25° C. to form a plurality of radical random copolymers;
i) maintaining the temperature of the admixture such that polymerization occurs; and
j) substantially reducing the polymerization and forming a second radical random copolymer.

23. The process of claim 17, further comprising:
g) mixing the radical polymer particulates with a third monomer and a free-radical-forming agent in a solvent, the third monomer being the same or different type than the first and second monomers; and
j) substantially reducing the polymerization and forming a second radical random copolymer.

24. The process of claim 22 or 23, wherein steps (g) through (j) are repeated with the same or different monomers to form subsequent radical random copolymers.

25. The process of claim 17, wherein the second monomer of step (a) is a free-radical-based monomer.

26. The process of claim 17, wherein the second monomer of step (a) is a surface-active monomer.

27. The process of claim 26 wherein the second monomer of step (a) is selected from the group consisting of fluorocarbons or silicone.

28. The process of claim 26, wherein the second monomer of step (a) is selected from the group consisting of TFE, CTFE, VDF, and VF.

29. The process of claim 17, wherein the first monomer of step (a) is vinylidene chloride.

30. The process of claim 22 or 23, wherein the third monomer of step (g) is GMA.

31. The process of any one of claims 1, 2, 8-12, 17, and 22-24, wherein the particulate solid yield from the reactor fluid is greater than 30%.

32. The process of claim 31, wherein the particulate solid yield from the reactor fluid is greater than 60%.

33. The process of claim 31 wherein the particulate solid yields from the reactor fluid is more than about 90%.

34. The radical copolymer formed by the process of any one of claims 2, 8-12, 17, and 22-24, stored in oxygen-free conditions at relatively low nonreactive temperatures, to be redistributed for further chain extension.

35. The process of any one of claims 1, 2, 8-12, 17, and 22-24, wherein the copolymer formed has a specific gravity greater than 1.3.

36. Process of any one of claims 1, 2, 8-12, 17, and 22-24, wherein the polymerization of second and subsequent monomer groups occurs under incomplete solubilization conditions for the radical polymer particulates, to result in core-shell type of polymer particulates.

37. A composition comprising the radical polymer produced by the method of any of claims 1, 2, 8-12, 17, and 22-24 comprising the copolymer of the type [(VDCₓM_{y})_{z}]*, where x,z≧1, y≧0, * is the radical end, VDC is the vinylidene chloride segment, and M is any free-radical-based monomer.

38. An admixture comprising a non-radical polymer and a non-radical copolymer formed from the radical polymer of claim 37.

39. The copolymer formed by the process of any one of claims 2, 8-12, 17, 22-24, and 37.
